(19) United States
(12) Patent Application Publication
(10) Pub. No.: US 2025/0220695 A1
(43) Pub. Date: Jul. 3, 2025

(54) MANAGED PEER-TO-PEER SERVICE OFFERING ON A WIRELESS LAN

(71) Applicant: Cisco Technology, Inc., San Jose, CA (US)

(72) Inventors: Robert E. BARTON, Richmond (CA); Jerome HENRY, Pittsboro, NC (US); Vinay SAINI, Bengaluru (IN); Juan Carlos ZUNIGA, Montreal (CA); Indermeet S. GANDHI, San Jose, CA (US)

(21) Appl. No.: 18/626,176

(22) Filed: Apr. 3, 2024

(30) Foreign Application Priority Data
Dec. 29, 2023 (IN) 202341089870

(51) Int. Cl. H04W 72/40; H04W 28/18; H04W 72/51; H04W 84/12

(52) U.S. Cl. CPC H04W 72/40; H04W 28/18; H04W 72/51; H04W 84/12

(57) ABSTRACT

Techniques for supporting peer-to-peer (P2P) communication are provided. A pre-association request from a first network device is sent by the first network device to a second network device, inquiring about a capacity of the second network device to support a peer-to-peer (P2P) communication within a network. A pre-association response is received from the second network device, confirming the capacity of the second network device to support the P2P communication. An association request is sent by the first network device to the second network device. An association response is received from the second network device, confirming a connection between the first and second network devices within the network. The P2P communication is conducted by the first network device with a third network device, using network resources allocated for the P2P communication by the second network device.

### CROSS-REFERENCE TO RELATED APPLICATIONS

This application claims benefit of co-pending Indian provisional patent application No. 202341089870 filed Dec. 29, 2023. The aforementioned related patent application is herein incorporated by reference in its entirety.

### TECHNICAL FIELD

Embodiments presented in this disclosure generally relate to wireless communication. More specifically, embodiments disclosed herein relate to methods of querying access point's (AP) support for Peer-to-Peer (P2P) communication before association.

### BACKGROUND

Peer-to-Peer (P2P) communication has become an area of interest in the development of Wi-Fi 8 technology. While P2P techniques allow devices to communicate directly with each other, they also introduce challenges, particularly interference from the surrounding WLAN infrastructure. Such interference may impact the efficiency and reliability of P2P connections. To address these issues, various strategies for managing these interactions have been proposed. However, there still remains a need for a more structured approach to handling P2P connections, especially from the perspective of Access Points (APs), for optimizing wireless spectrum usage and minimizing interference between P2P and traditional WLAN operations.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless network environment that supports P2P communication, according to some embodiments of the present disclosure.

FIG. 2 depicts an example process of querying for an AP's P2P support prior to association, according to some embodiments of the present disclosure.

FIG. 3 depicts an example process of requesting extensions for peer-to-peer (P2P) communication, according to some embodiments of the present disclosure.

FIG. 4 depicts an example process of determining P2P connections based on received offers from two different APs, according to some embodiments of the present disclosure.

FIG. 5 depicts an example method of a client device communicating peer-to-peer on allocated resources, according to some embodiments of the present disclosure.

FIG. 6 depicts an example method of an AP assessing network load and allocating resources for P2P communication, according to some embodiments of the present disclosure.

FIG. 7 is a flow diagram depicting an example method for negotiating P2P support prior to association, according to some embodiments of the present disclosure.

FIG. 8 depicts an example client device supporting P2P communication, according to some embodiments of the present disclosure.

FIG. 9 depicts an example AP supporting P2P communication, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including sending a pre-association request, by a first network device, to a second network device, inquiring about a capacity of the second network device to support a peer-to-peer (P2P) communication within a network, receiving a pre-association response from the second network device, confirming the capacity of the second network device to support the P2P communication, sending an association request, by the first network device, to the second network device, receiving an association response from the second network device, confirming a connection between the first and second network devices within the network; and conducting the P2P communication, by the first network device, with a third network device, using network resources allocated for the P2P communication by the second network device.

Other embodiments in this disclosure provide one or more non-transitory computer-readable media containing, in any combination, computer program code that, when executed by operation of a computer system, performs operations in accordance with one or more of the above methods, as well as systems comprising one or more computer processors and one or more memories collectively containing one or more programs, which, when executed by the one or more computer processors, perform operations in accordance with one or more of the above methods.

### Example Embodiments

The present disclosure provides techniques for optimizing P2P communication, which includes inquiring about and negotiating network resources for P2P communication prior to association with an AP, and making informed decisions on connection based on the results of these inquiries and negotiations.

Access Network Query Protocol (ANQP) is a protocol defined within the 802.11u standard, and is used in Wi-Fi networks to enable devices (like smartphones, laptops, etc.) to obtain information about available Wi-Fi networks and their capabilities before connection. The protocol is mainly used by devices to gather detailed information about the services and features available on various Wi-Fi networks. By learning the available services and features, devices can make informed decisions on which network to join based on their specific needs or preferences.

Embodiments of the present disclosure introduce a mechanism that integrates ANQP messages into P2P communication. A peer device utilizes an ANQP request to inquire about an AP's capability to support P2P communication before connecting to the AP's associated network. Upon receiving the request, the AP evaluates its current load to determine if it can allocate a frequency block to the peer device for P2P communication. In embodiments where the AP supports P2P communication and has sufficient capacity, the AP may send an ANQP response to the peer device, confirming its support for P2P associated services. In some embodiments, the ANQP response may further include details about the P2P service offerings, including bandwidth availability (e.g., 20 MHz, 40 MHz), and the duration that the peer device can use the P2P channel. In some embodiments, the peer device may receive P2P service offerings from multiple APs. In such configurations, the peer device may compare these offers and decide on the most suitable AP to connect based on factors like better bandwidth or longer duration.

Once the confirmation is received, the peer device proceeds to connect to the AP and utilizes the allocated frequency block for P2P communication. If the response indicates that the AP cannot support P2P communication or lacks the necessary bandwidth, the peer device then searches for other networks within its range. In some embodiments, the peer device may negotiate the resources allocated for P2P communication either before or after association, using ANQP or other dedicated action frames. When receiving the connection request from the peer device, the AP sends an acknowledgement and proceeds to puncture the agreed-upon frequency block. The peer device then initiates the P2P transmission using the allocated frequency block. At the end of the reserved period, the peer device may, in some embodiments, request an extension using ANQP or other dedicated action frames, depending on the device's ongoing communication needs. The AP may deny or approve the extension, considering its current capacity and policy for extending such communications.

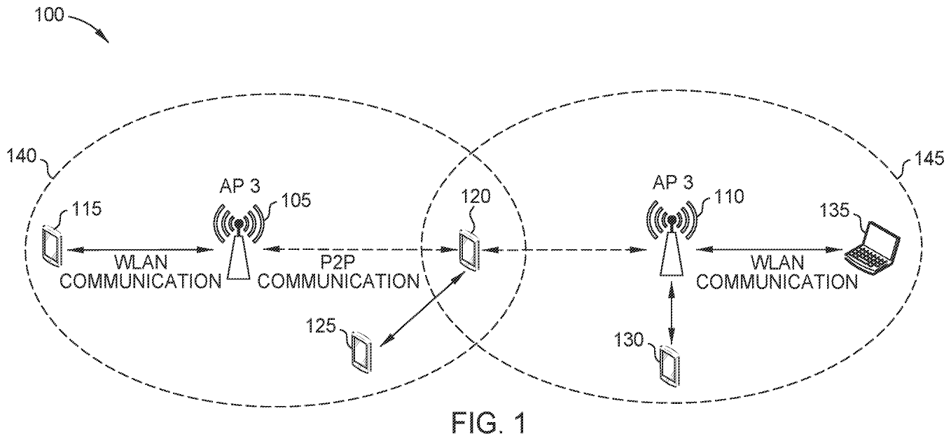

FIG. 1 depicts an example wireless network environment 100 that supports P2P communication, according to some embodiments of the present disclosure.

In the illustrated example environment 100, two access points (APs) are depicted, each providing coverage to specific user devices (STAs) within its range for either regular Wireless Local Area Network (WLAN) communications or peer-to-peer (P2P) communications. STA 115 is within the coverage area 140 of AP 105 and is engaged in WLAN communication with AP 105. STA 120 is within the overlapping coverage area of both APs 105 and 110, and intends to communicate directly with STA 125. STAs 130 and 135 fall within the coverage area 145 of AP 110, and are engaged in WLAN communication with AP 110.

As illustrated, since STA 120 is within the overlapping coverage area of both AP 105 and AP 110, STA 120 may connect to either AP (e.g., AP 105 or AP 110) for initiating P2P communication with STA 125. In some embodiments, STA 120 may send ANQP requests to both APs 105 and 110, to query their capabilities to support P2P communication, respectively. Upon receiving the responses from both APs, STA 120 can make an informed decision on which AP to connect to. For example, if AP 105 indicates it cannot support P2P communication while AP 110 confirms its support for P2P, STA 120 may decide to connect to AP 110, given its intent to communicate directly with STA 125. If both APs indicate support for P2P and include details about the frequency block that can be assigned, such as bandwidth availability (e.g., 20 MHz, 40 MHZ) and duration (e.g., 5 minutes), STA 120 may compare these offers. Based on the comparison, the STA 120 may decide which AP's service to utilize, considering factors like bandwidth needs, duration of the communication, and signal strength or quality (e.g., received signal strength indicator (RSSI), signal-to-noise (SNR)) of services from each AP, among others.

APs 105 and 110 may be wireless routers, network switches, mesh network nodes, or other devices that provide connectivity and support for various network services, including but not limited to distributing IP addresses, providing wireless access for devices, managing network traffic, and facilitating secure data transmission. STAs may be stationary or mobile, and may be referred to as user devices (UEs), client devices, mobile devices, and terminals or access terminals, among others. STAs may represent any devices capable of connecting to a wireless network to access services and communicate with other devices within the network. STAs may include a wide range of device types, including, but not limited to, smartphones, tablets, laptops, smart sensors, and other Internet of Things (IoT) devices.

As used herein, WLAN communication refers to communications between a STA and an AP, for example, a laptop connecting to a home Wi-Fi network for internet access. P2P communication refers to direct communication between two or more STAs, without going through the AP, such as file sharing directly between two or more smartphones. A P2P link refers to a communication link established between two or more STAs engaged in P2P communication. A P2P group refers to a group of STAs that have formed a network to facilitate direct P2P communication among themselves. In the illustrated example, STAs 120 and 125 form a P2P group. In some embodiments, one STA in the P2P group may serve as the P2P group owner (also referred to in some embodiments as P2P seeker or P2P server), initiating the communication, while the remaining STAs in the P2P group may serve as P2P clients (also referred to in some embodiments as P2P receiver). The P2P group owner may be configured to perform functions that initiate and manage the P2P communication, which include but are not limited to querying APs for compatible P2P services, selecting P2P clients based on criteria such as signal strength, device capability, and/or user preferences, initiating the connection process, and negotiating network resources allocated for P2P communication. For successful P2P communication, in some embodiments, the P2P group owner may maintain its connection to the AP, and remain within its coverage area. This association ensures that the P2P group owner, in such a configuration, receives the necessary network support to facilitate P2P communication, and utilize the AP's infrastructure for optimal (or at least improved) connectivity and performance.

In the illustrated example, STA 120 acts as the P2P group owner that initiates the process of establishing a P2P communication link, while STA 125 serves as the P2P client, being receptive to the connection requests from STA 120 and engaging in the mutual establishment of a P2P link. STA 120, being within the coverage areas 140 and 145 of both AP 105 and 110, has the flexibility to associate with either AP to satisfy its P2P communication requirements. With this association, P2P link between STA 120 and STA 125 can be effectively established and maintained to enable direct device-to-device interactions within the wireless network environment.

Although STA 125 is depicted as being within the coverage 140 of AP 105, in some embodiments, STA 125 may be outside of the direct coverage of both APs 105 and 110. In such configurations, P2P communication between STAs 120 and 125 remains feasible as long as STA 120, which facilitates the connection (as the P2P group owner), is within the coverage area of either AP 105 or AP 110. The inclusion of STA 120 in either coverage area (e.g., 140 or 145) enables it to connect to the corresponding AP for P2P communication.

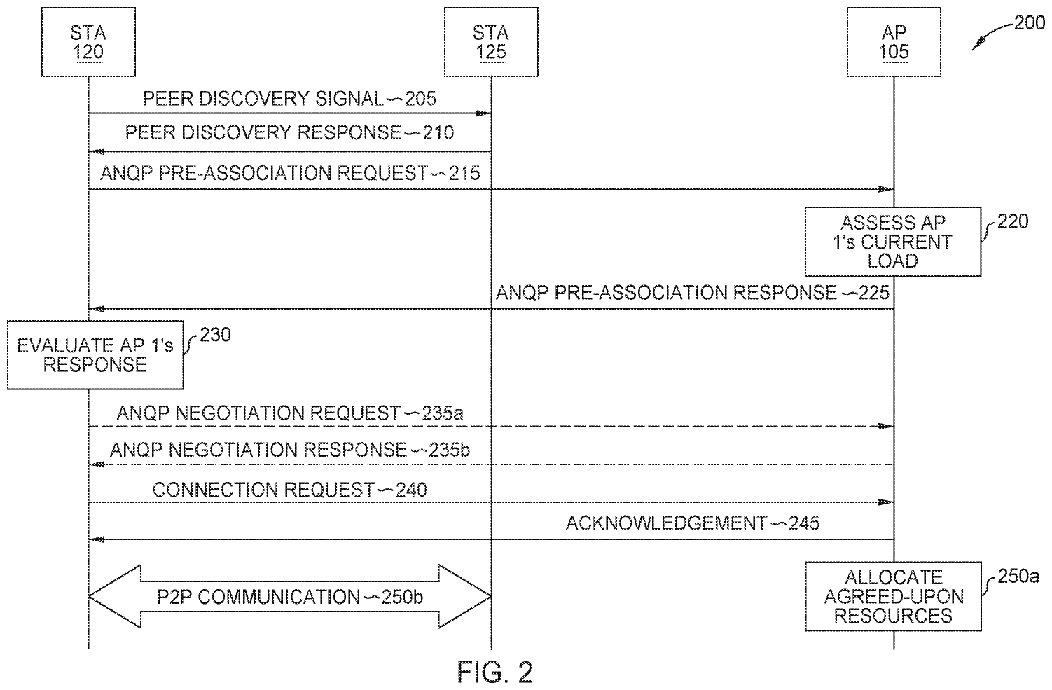

FIG. 2 depicts an example process 200 of querying for an AP's P2P support prior to association, according to some embodiments of the present disclosure.

In the illustrated example process, STA 120 (which may correspond to STA 120 as depicted in FIG. 1), as the P2P group owner, broadcasts a peer discovery signal to its surroundings using P2P discovery protocols (step 205). In some embodiments, the signal may indicate the presence of the STA 120, and include information such as the STA 120's identity, its capability, and details about the P2P services it seeks or offers. STA 125 (which may correspond to STA 125 as depicted in FIG. 1), as the P2P client, detects the discovery signal and responds with a peer discovery response packet (step 210). In some embodiments, the response may include STA 125's identity, its capability, and a confirmation of its willingness to engage in P2P communication with STA 120.

Following the peer discovery procedure, STA 120 sends a pre-association request to AP 105 (step 215). STA 120 falls within the coverage area of AP 105 (which may correspond to AP 105 as depicted in FIG. 1). In some embodiments, the pre-association request may use ANQP or other action frames, and query the AP 105's capability to support P2P communications. In some embodiments, the pre-association request may ask about the AP 105's available bandwidth, supported frequencies, and any network policies related to P2P operations.

The illustrated example that depicts STA 120 interacting with a single AP is provided for conceptual clarity. In some embodiments, STA 120 may be located within the overlapping zones of multiple APs (e.g., AP 105 and AP 110 of FIG. 1), and therefore may send the ANQP pre-association requests to all accessible APs to evaluate which offers the most favorable conditions for P2P communication.

The AP 105, upon receiving the pre-association request, evaluates its current network load (step 220), considering factors such as the total bandwidth usage, the number of connected devices, the current network traffic load (e.g., the amount of data queued up at AP 105 and its associated STAs), signal strength (e.g., RSSI, SNR), and any quality of service (QOS) requirements. Based on the assessment, AP 105 determines the network resources that can be offered to STA 120 for P2P communication without compromising the network performance for other users (e.g., 115 of FIG. 1). In some embodiments, the resources may include a frequency block, which involves reserving a specific segment of bandwidth (e.g., 20 MHZ, 40 MHZ) within the wireless spectrum for STA 120's exclusive use over a certain period of time (e.g., 2 minutes). For example, AP 105 may offer 20 MHz within a specific frequency range (e.g., UNII-7) to be utilized exclusively by STA 120 for P2P operations for a duration of 2 minutes.

Based on the assessment, AP 105 sends a pre-association response to STA 120 (step 225). In some embodiments, the response may only indicate whether P2P communication is supported by AP 105 under the current network conditions. In some embodiments, the response may further include specific details about the frequency block that could be allocated to STA 120, such as its bandwidth (e.g., 20 MHz, 40 MHZ), the permissible duration for P2P use, and the time frame when it becomes available. STA 120 evaluates the response and decides whether to connect (step 230). If the ANQP pre-association response indicates that it does not support P2P communication (e.g., due to network policy restrictions, insufficient bandwidth availability, or the AP 105's hardware limitations), STA 120 may then proceed to search for other nearby APs that could potentially support its P2P communication needs. If AP 105's response indicates support for P2P communication and includes details about the resources that could be allocated (e.g., a frequency block), STA 120 may proceed to evaluate the offered resources. If STA 120 determines the resources, such as the promised frequency block, to be insufficient for its needs, STA 120 may send an ANQP negotiation request to AP 105 (step 235a), asking for a reassessment or an improved offer. In response to the negotiation request, AP 105 may reevaluate its resource management policies and current network usage, and send back a negotiation response (step 235b). In some embodiments, AP 105's negotiation response may include an adjusted resource allocation that better meets STA 120's requirements. In some embodiments, such as when additional resource allocation for STA 120 is not feasible (e.g., due to network policy restrictions or insufficient bandwidth availability), the response may provide explanations regarding these limitations. In some embodiments, the negotiation for resource allocation may occur after STA 120 has already connected to AP 105 (after step 240), using ANQP or other suitable action frames.

After negotiating and reaching an agreement on the resources offered by AP 105 for P2P communication, STA 120 sends a connection request (also referred to in some embodiments as an association request) to AP 105 (step 240). The request indicates STA 120's intent to join AP 105's WLAN network, thereby utilizing AP 105's infrastructure for P2P communication. Following STA 120's P2P connection request, AP 105 sends an acknowledgement back to STA 120 (step 245), confirming its successful association with the WLAN network. In some embodiments, the acknowledge may inform STA 120 that it is now a client of AP 105's network, and can utilize the agreed-upon resources for P2P communication. After sending the acknowledgement, AP 105 then proceeds to allocate the specific frequency block for STA 120's for P2P communication (step 250a). This step may involve adjusting the network's resource management to puncture the agreed-upon bandwidth from AP 105's available spectrum, reserving it specifically for STA 120's P2P use for the agreed-upon duration. For example, if the agreed-upon frequency block involves a 20 MHz bandwidth within the UNII-7 band for a duration of 5 minutes, AP 105 may puncture the available spectrum (specially the UNII-7 band) to allocate the specific segment (the 20 MHZ) exclusively for STA 120's P2P communication for 5 minutes. The allocation ensures that the 20 MHz bandwidth is reserved solely for the use of STA 120, and prevents other network activities from interfering within this frequency range for the set duration. With the network resource allocated and the necessary configuration set by AP 105, STA 120 initiates the P2P communication with STA 125 (step 250b).

In some embodiments, after receiving the acknowledgement, STA 120 may send a message to STA 125, notifying STA 125 of the details regarding the allocated frequency block for P2P communication. The message may include information such as the specific frequency range to be used, the bandwidth allocated (e.g., 20 MHZ), and the duration for which the allocation is valid (e.g., 2 minutes). STA 125, upon receiving the message, may adjust its setting to align with the specified parameters for the P2P session.

Although the illustrated example that depicts a P2P group that includes two STAs (STA 120 and STA 125) is discussed for conceptual clarity, in some embodiments, the P2P group may include any number of STAs. Each STA within the group may be allocated specific network resources based on AP 105's capacity and the negotiated terms, to ensure efficient management and utilization of the available spectrum for P2P communication.

The illustrated example depicts that only the P2P group owner (e.g., STA 120) communicates with the AP 105 for network assistance for P2P communication (e.g., sending the ANQP pre-association request or negotiation request), and then conveys the relevant information to the P2P clients (e.g., STA 125) within the group. The example is provided for conceptual clarity. In some embodiments, both the P2P group owner (e.g., STA 120) and the P2P clients (e.g., STA 125) may communicate directly with AP 105 for network assistance related to P2P communication. The direct communication may facilitate a more dynamic and flexible P2P environment where each STA within the P2P group can individually negotiate and/or request specific network resources or assistance from AP 105.

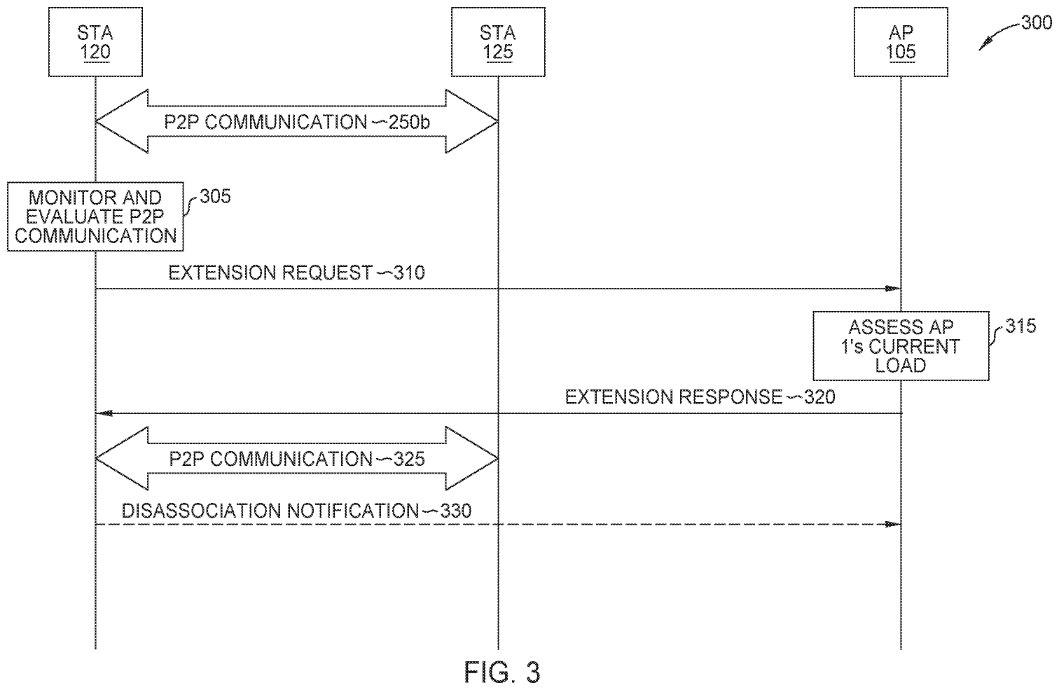

FIG. 3 depicts an example process 300 of requesting extensions for peer-to-peer (P2P) communication, according to some embodiments of the present disclosure.

In the illustrated example, STA 120 and STA 125 conduct the P2P communication using the allocated network resources (step 250b). During the P2P operation, STA 120 continuously monitors the quality of the transmission, and/or evaluates its ongoing needs for the P2P session (step 305). If STA 120 determines that the allocated frequency block is insufficient to complete its P2P data transmission, STA 120 sends an extension request to AP 105 for additional resources or time (e.g., requesting an additional 20 MHz of bandwidth within the same frequency block or an extension of the communication time by another 5 minutes) (step 310). Upon receiving the extension request, AP 105 conducts another assessment to determine its current network load (step 315). As discussed above, various factors may be considered, including, but not limited to, the total bandwidth usage, the number of connected devices, the current network traffic load (e.g., the amount of data queued up at AP 105 and its associated STAs), signal strength, and any quality of service (QOS) requirements. The evaluation ensures that the extension of the current P2P session for STA 120 does not adversely affect the network's performance for other users or conflict with its established QoS policies regarding resource allocation and network usage.

Based on the evaluation, AP 105 sends a response to STA 120 (step 320). The response may include an approval for the extension request with details on the additional resource allocated or a denial if the network cannot accommodate the request due to load or policy limits. If the response includes an approval, STA 120 and STA 125 may continue their P2P communication with the extended resources (step 325). If the response includes a denial, STA 120 may proceed to conclude the P2P session as originally agreed, and then decides whether to leave the current network to seek alternative options (e.g., other nearby APs) for its communication needs. If STA 120 decides to leave, it sends a disassociation notification to AP 105 (step 330), which informs AP 105 of the end of its association with the network. In some embodiments, the extension request/response transmitted between AP 105 and STA 120 may use ANQP or other defined action frames specific for P2P communication (e.g., Wi-Fi Direct action frames).

In some embodiments, when the extension response indicates a denial to extend the original allocated frequency block, it may further include information about another frequency block that can be allocated to STA 120 at a later time. The response may include details of the new frequency block, such as its bandwidths, the frequency range, the duration for which it can be used, and the time frame when it becomes available, among others. The alternative offer may provide STA 120 with options for continuing its P2P communication despite the immediate unavailability of additional resources. Through the response, STA 120 may learn potential future network resources, and adjust its plan accordingly (e.g., leaving or staying with AP 105's network).

Although the illustrated example that depicts a P2P group that includes two STAs (STA 120 and STA 125) is discussed for conceptual clarity, in some embodiments, the P2P group may include any number of STAs. Each STA within the group may be allocated specific network resources based on AP 105's capacity and the negotiated terms, to ensure efficient management and utilization of the available spectrum for P2P communication.

The illustrated example depicts that only the P2P group owner (e.g., STA 120) communicates with the AP 105 for network assistance for P2P communication (e.g., sending the extension request), and then conveys the relevant information to the P2P clients (e.g., STA 125) within the group. The example is provided for conceptual clarity. In some embodiments, both the P2P group owner (e.g., STA 120) and the P2P clients (e.g., STA 125) may communicate directly with AP 105 for network assistance related to P2P communication.

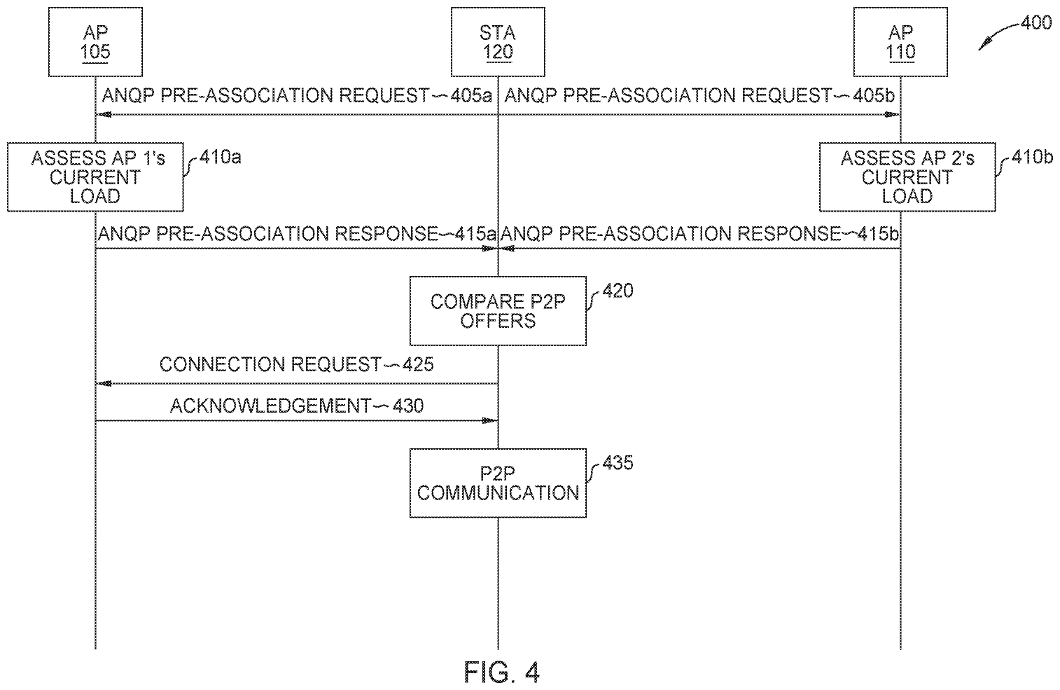

FIG. 4 depicts an example process 400 of determining P2P connections based on received offers from two different APs, according to some embodiments of the present disclosure.

In the illustrated example process, STA 120 (which may correspond to STA 120 as depicted in FIG. 1), as the P2P group owner, sends a ANQP pre-association request to both AP 105 and AP 110 (simultaneously or sequentially) (which may correspond to APs 105 and 110 as depicted in FIG. 1), inquiring about their capabilities to support P2P communication (steps 405a and 405b). In some embodiments, STA 120 may be positioned within the signal coverage of both AP 105 and AP 110 (as depicted in FIG. 1).

Each AP (e.g., AP 105 and AP 110), upon receiving the request, evaluates its current traffic load and network capacity to determine the resources that can be allocated to STA 120 for P2P communication (steps 410a and 410b). In some embodiments, the assessment may involve determining the available bandwidths (e.g., 20 MHZ) and duration for which they can be used (e.g., 5 minutes) without impacting the service quality for other network users. Based on the evaluations, AP 105 and AP 110 each send a response to STA 120 (steps 415a and 415b), which details their respective offers for P2P communication. In some embodiments, the responses may include parameters on the available frequency blocks, including their bandwidths, frequency ranges, and durations for P2P communication. STA 120 then compares the P2P offers from AP 105 and AP 110 (step 420). A variety of factors may be considered during the comparison, such as the amount of bandwidth offered, the suitability of the frequency block for its communication needs, and the duration for which the resources are available. In some embodiments, STA 120 may further consider the proximity of each AP, its signal strength (e.g., RSSI, SNR), and the potential interference (e.g., from WLAN signals) on the P2P communications.

In the illustrated example, STA 120, based on the comparison, decides that the promised resources offered by AP 105 better meet its P2P communication requirements than AP 110. STA 120 therefore sends a connection request (also referred to in some embodiments as an association request) to AP 105 (step 425). The request indicates STA 120's intent to utilize AP 105's network for the P2P communication. Upon receiving the request, AP 105 sends an acknowledgement back to STA 120 (step 430). Following the successful association with AP 105, P2P communication is initiated (step 435). The STA 120 may use the allocated frequency block from AP 105 to exchange data directly with its intended P2P clients (e.g., STA 125 of FIG. 3).

The illustrated example that depicts the P2P group owner (e.g., STA 120) querying for P2P support from two APs, and then comparing the offers to decide on the more suitable AP for establishing the association, is provided for conceptual clarity. In some embodiments, the P2P group owner may send pre-association requests to any number of APs nearby, and compare their responses to optimize the P2P communication setup.

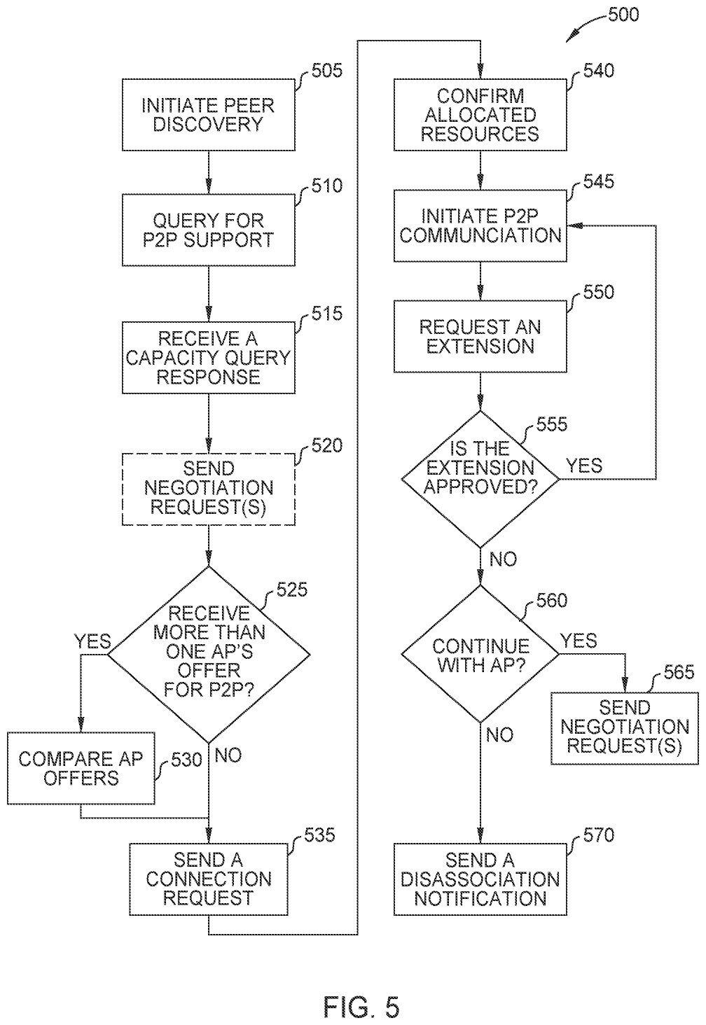

FIG. 5 depicts an example method 500 of a client device communicating peer-to-peer on allocated resources, according to some embodiments of the present disclosure. In some embodiments, the method 500 may be performed by one or more network devices, such as STA 120 as depicted in FIGS. 1, 2, 3, and 4.

The method 500 begins at block 505, where a STA (e.g., STA 120 of FIG. 1) initiates a peer discovery procedure to search for and identify other devices within its range that are capable of (and/or interested in) participating in P2P communication. In some embodiments, the peer discovery process may involve the STA broadcasting signals to its surroundings. The signal may include the STA's identity (e.g., MAC address), intent and capacity to engage in P2P sessions. Upon detecting these signals, other STAs (e.g., STA 125 of FIG. 1) may send back a response, indicating their willingness and capacity to form a P2P link. Following the exchange, the STA may negotiate with the recipient STAs for P2P connection parameters, including determining the group owner and/or defining the roles of each device within the P2P group. Once these parameters have been agreed upon, the STAs (e.g., 120 and 125 of FIG. 1) proceed to establish the P2P link within the group, using protocols such as Wi-Fi Direct or other similar protocols that facilitate direct device-to-device communication.

At block 510, the STA (e.g., 120 of FIG. 1), acting as the P2P group owner, sends queries to nearby APs to determine support for P2P communication. The query process occurs before the STA associates with any AP. The requested information ensure that the STA makes informed decisions before joining any network for P2P operations. To facilitate the inquiry, in some embodiments, the STA may utilize the ANQP or other suitable action frames designed for such pre-association communications.

At block 515, the STA receives a response from the queried APs regarding their capabilities to support P2P communication. In some embodiments, an AP's responses may include a simple confirmation or denial of P2P support, considering its current network conditions, policy limitations, and hardware constraints. In some embodiments, an AP's response may further include detailed information about the specific resources that can be allocated by the AP for P2P use. As discussed above, such details may include the available frequency range and the bandwidth, the duration for which these resources can be used, and the time frame when these resources become available.

At block 520, for these APs that have replied with support for P2P, the STA may optionally send negotiation requests (e.g., indicated by the dashed line 520). The negotiation process allows the STA to request adjustments or enhancements to the initial offer, such as securing a wider bandwidth or extending the duration for which the resources can be used. In some embodiments, the negotiation process may occur after the STA has been associated with a selected AP.

At block 525, the STA evaluates whether it has received offers for P2P support from more than one AP. If the STA receives multiple offers from different APs (such as AP 105 and AP 110 as depicted in FIG. 4, with both confirming support for P2P and indicating the resources that can be allocated to the STA), the method 500 proceeds to block 530, where the STA compares the P2P offers from each AP to determine which one better meets its requirements for P2P communication. In some embodiments, the comparison may include assessing the parameters within each offer, such as the bandwidth availability, frequency range, duration of allocation, and any other relevant conditions. If the STA has received an offer from only one AP (such as AP 105 indicating its support while AP 110 providing a negative response), the method 500 proceeds directly to block 535, where the STA sends a connection request to the AP (e.g., AP 105 as depicted in FIG. 4), bypassing the need for further comparison.

At block 535, the STA selects an AP based on the comparison, and sends a connection request to join the selected AP's network.

At block 540, the STA receives an acknowledgement from the selected AP, which confirms the agreed-upon resources for P2P communications. The acknowledgement indicates the AP's commitment to providing the specified resources, such as the bandwidth and duration that have been negotiated for the P2P session. In some embodiments, following the receipt of the acknowledgement, the STA may send the confirmed P2P parameters (e.g., the frequency band to be used, the allocated bandwidth, and the duration) to other P2P clients within the group (e.g., STA 125 of FIG. 2). The transmission ensures all members of the P2P group are aware of and can configure their settings to the agreed-upon resources for the P2P session.

At block 545, with the P2P preparation completed (e.g., the specific P2P parameters have been communicated to all involved parties), the P2P communication session is initiated between the STA and its intended P2P clients (e.g., 125 of FIG. 1).

At block 550, the STA, acting as the P2P group owner, requests an extension upon determining that additional resources or extended time are needed for P2P communication. For example, the request may include requesting an additional 20 MHz of bandwidth within the same frequency block, or extending the communication time for another 5 minutes. The need may arise from various factors, such as that the session requires more time than initially anticipated, or the data exchange volume exceeds the original estimate. Upon receiving the request, the AP may perform another round of evaluation to determine whether it can accommodate the extension request.

At block 555, the STA decides whether the extension request has been approved. If the extension request is approved, the method 500 returns to block 545, where the STA and other P2P clients within the group continue the P2P communication following the new terms. If the extension request is denied (e.g., due to insufficient network resources or policy restrictions), the method proceeds to block 560, where the STA decides whether to continue the association with the current AP. If the STA decides to continue with the current AP (despite the denial of the extension request), the method 500 proceeds to block 565, where the STA sends another negotiation request(s) to the connected AP. The negotiation request(s) may be used to explore other possible adjustments or accommodations that could be made to support the STA's communication needs, such as seeking alternative transmission opportunities at a later time. If the STA decides to leave the current AP (due to the denied extension request), the method 500 proceeds to block 570, where the STA sends a disassociation notification to the AP, formally ending its connection to the AP's network. The disassociation decision may be made when STA determines that seeking an alternative network environment may better accommodate its P2P communication requirements than staying with the current AP. In some embodiments, before making the final decision to dissociate, the STA may first send another ANQP pre-association query to another nearby AP to explore additional options for supporting its P2P communication needs. Based on the received response from the new AP (which includes details on the available resources offered by the new AP), the STA may evaluate whether the new AP offers a more suitable environment for its P2P communication compared to the current AP. If the response from the new AP presents a more favorable option that better meets the STA's requirements, the STA may then decide to proceed with disassociating from the current AP.

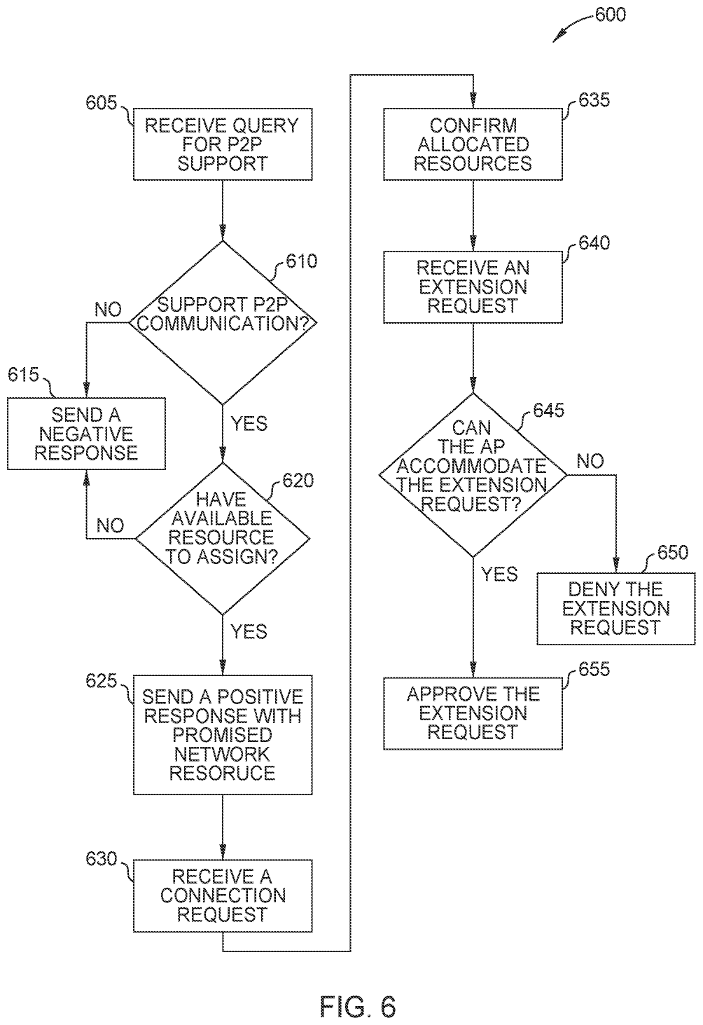

FIG. 6 depicts an example method 600 of an AP assessing network load and allocating resources for P2P communication, according to some embodiments of the present disclosure. In some embodiments, the method 600 may be performed by one or more network devices, such as APs 105 and 110 as depicted in FIGS. 1 and 4, AP 105 as depicted in FIGS. 2 and 3.

At block 605, an AP (e.g., 105 of FIG. 1) receives a pre-association query from a nearby STA (e.g., 120 of FIG. 1), asking about the AP's capability and available resources to support P2P communication.

At block 610, the AP determines whether it can support P2P communication. In some embodiments, the determination may involve assessing the AP's technical specifications to ensure it has the necessary hardware and software features to facilitate P2P sessions, and reviewing the network policies or regulations that may impact the AP's capability to support P2P communication. If the AP cannot support P2P communication (e.g., due to its configuration, policies, or other limitations), the method 600 proceeds to block 615, where the AP sends a negative response to the STA. In some embodiments, the negative response may indicate the AP's inability to support P2P sessions. If P2P communication is supported, the method 600 proceeds to block 620, where the AP evaluates its current traffic load and network capacity to determine if there are resources available to allocated to the STA. If resources are available, the method 600 proceeds to block 625. Otherwise, the method 600 proceeds to block 615, where a negative response is sent to the requested STA.

At block 625, the AP sends a positive response to the requested STA, confirming its support for P2P communication. In some embodiments, the positive response may further include details about the specific resources that can be allocated to the STA for P2P communication, including the available bandwidth and frequency range, and the duration for which the bandwidth can be accessed.

At block 630, the AP receives a connection request (also referred to in some embodiments as an association request) from the STA. The request may indicate the STA′ intent to join the AP's WLAN network, and therefore use the AP's promised resources for P2P communication.

At block 635, the AP sends an acknowledgement to the STA, confirming the allocation of the promised resources for P2P communication. Following the confirmation, P2P communication is initiated between the STA and other paired P2P client devices (e.g., STA 125 of FIG. 1).

At block 640, the AP receives a request to extend the P2P session beyond the initially agreed-upon duration or resources. As discussed above, the need for extension may arise from a variety of factors that were not fully anticipated at the beginning of the P2P communication session. For example, the session may require more time than was initially anticipated due to the nature of the communication or interaction between the devices (e.g., extended discussions or interactions), the volume of data being exchanged between the participating STAs may exceed the original estimates, or the data transfer rate during the P2P session may be slower than expected (e.g., due to interference or signal strength variations).

At block 645, the AP reevaluates its traffic load and resource availability to determine if it can accommodate the extension request. If the AP determines that it can accommodate the extension request (e.g., extending the assigned frequency block for another 5 minutes), the method 600 proceeds to block 655, where the AP approves the extension request. In some embodiments, the AP may send a response to the STA, providing parameters about the additional resources for the P2P session. If the AP determines that it cannot accommodate the extension request (e.g., due to insufficient resources or policy limitations), the method 600 proceeds to block 650, where the AP denies the extension request.

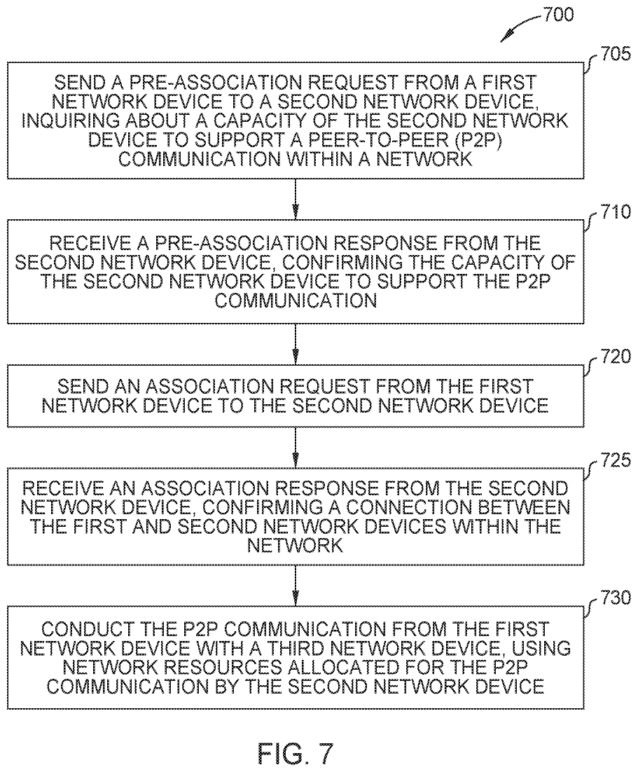

FIG. 7 is a flow diagram depicting an example method 700 for negotiating P2P support prior to association, according to some embodiments of the present disclosure.

At block 705, a first network device (e.g., STA 120 of FIG. 1) sends a pre-association request to a second network device (e.g., AP 105 of FIG. 1), inquiring about a capacity of the second network device to support a peer-to-peer (P2P) communication within a network. In some embodiments, the second network device may comprise an access point (e.g., AP 105 of FIG. 1). In some embodiments, the first network device (e.g., STA 120 of FIG. 1) may comprise a station (STA) that manages the P2P communication, and the first network device is within a coverage area (e.g., 140 of FIG. 1) of the second network device.

At block 710, the first network device receives a pre-association response from the second network device, confirming the capacity of the second network device to support the P2P communication (as depicted by block 515 of FIG. 5). In some embodiments, the pre-association response may comprise network resources promised to be allocated for the P2P communication by the second network device, and the network resources may comprise at least one of a bandwidth allocation or a timeslot for channel usage. In some embodiments, the network resources allocated for the P2P communication may be determined by the second network device, based on an assessment of a current operational load of the second network device, considering at least one of (i) a number of stations (STAs) connected to the second network device, (ii) an amount of data queued up at the second network device, (iii) an amount of data queued up at the connected STAs, (iv) a signal strength between the second network device and the connected STAs.

At block 715, the first network device sends an association request to the second network device (as depicted by block 535 of FIG. 5).

At block 720, the first network device receives an association response from the second network device, confirming a connection between the first and second network devices within the network (as depicted by block 540 of FIG. 5).

At block 720, the first network device conducts the P2P communication with a third network device (e.g., STA 125 of FIG. 1), using network resources allocated for the P2P communication by the second network device.

In some embodiments, the first network device may further send an action frame to negotiate the network resources promised to be allocated for the P2P communication by the second network device (as depicted by block 520 of FIG. 5).

In some embodiments, while conducting the P2P communication, by the first network device, with the third network device, the first network device may further determine that the network resources allocated by the second network device are insufficient, and send an extension request to the second network device, requesting additional network resources (as depicted by block 550 of FIG. 5).

In some embodiments, the first network device may further receive a second pre-association response from the second network device, indicating that the second network device does not have sufficient bandwidth to support the P2P communication. In such configurations, the first network device may identify a fourth network device, and send a second pre-association request, by the first network device, to a fourth network device, inquiring about a capacity of the fourth network device to support the P2P communication within the network.

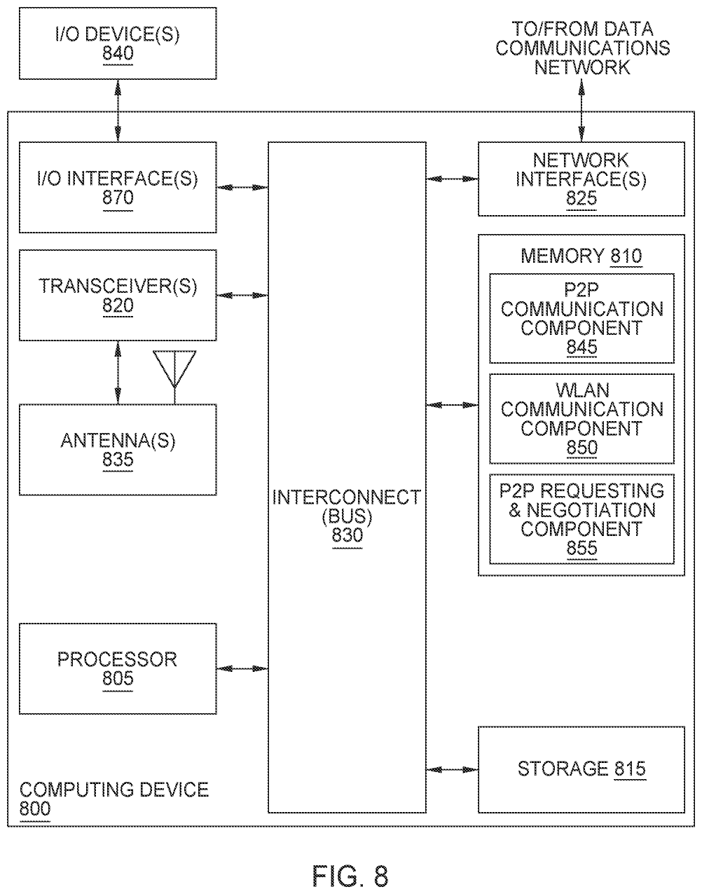

FIG. 8 depicts an example client device 800 supporting P2P communication, according to some embodiments of the present disclosure. In some embodiments, the example client device 800 may correspond to the STAs 120 and 125 as depicted in FIGS. 1, 2, and 3, and the STA 120 as depicted in FIG. 4.

As illustrated, the client device 800 includes a processor 805, memory 810, storage 815, one or more transceivers 820, one or more I/O interfaces 870, and one or more network interfaces 825. In some embodiments, I/O devices 840 are connected via the I/O interface(s) 870. Further, via the network interface 825, the client device 800 can be communicatively coupled with one or more other devices and components (e.g., via a network, which may include the Internet, local network(s), and the like). Each of the components is communicatively coupled by one or more buses 830. In some embodiments, one or more antennas 835 may be coupled to the transceivers 820 for transmitting and receiving wireless signals.

The processor 805 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 805 processes information received through the transceiver 820, I/O interfaces 870, and the network interfaces 825. The processor 805 retrieves and executes programming instructions stored in memory 810, as well as stores and retrieves application data residing in storage 815.

The storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for efficient functioning of the system.

The memory 810 may include random access memory (RAM) and read-only memory (ROM). The memory 810 may store processor-executable software code containing instructions that, when executed by the processor 805, enable the device 800 to perform various functions described herein for wireless communication. In the illustrated example, the memory 810 includes three software components: the P2P communication component 845, the WLAN communication component 850, and the P2P requesting and negotiation component 855. In some embodiments, the P2P communication component 845 may be configured to manage the P2P communication activities. For example, the component 845 may scan for and identify P2P communication partners within its proximity, manage the exchange of data directly between devices, and oversee the control of P2P sessions. In some embodiments, the WLAN communication component 850 may support WLAN communications, such as scanning for and recognizing available WLAN devices within its range, handling association and authentication requests to ensure secure access, and monitoring the data transfer over the network. In some embodiments, the P2P negotiation and requesting component 855 may be configured to handle the P2P pre-association queries or negotiation requests. For example, the component 855 may communicate with APs or other devices to negotiate the resources (such as the frequency blocks) required for P2P communication. The component 855 may assess the responses from APs regarding P2P support, and determine which AP better suits its requirements for connection. The component 855 may handle the sending of requests for session extensions based on ongoing communication needs.

Although depicted as a discrete component for conceptual clarity, in some embodiments, the operations of the depicted components (and others not illustrated) may be combined or distributed across any number of components. Further, although depicted as software residing in memory 810, in some embodiments, the operations of the depicted components (and others not illustrated) may be implemented using hardware, software, or a combination of hardware and software.

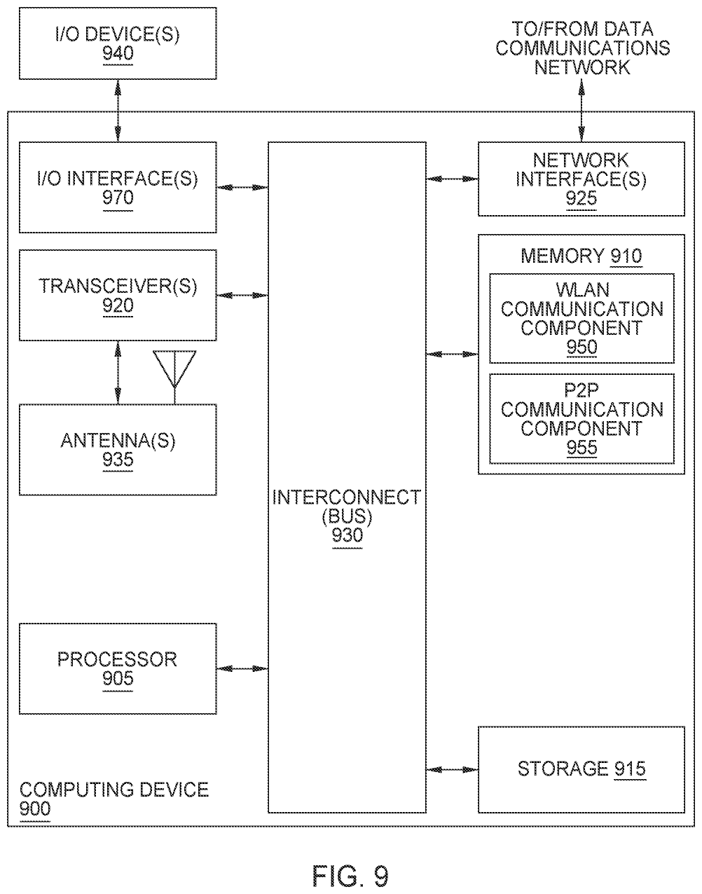

FIG. 9 depicts an example AP 900 supporting P2P communication, according to some embodiments of the present disclosure. In some embodiments, the example AP 900 may correspond to the APs 105 and 110 as depicted in FIGS. 1 and 4, the AP 105 as depicted in FIGS. 2 and 3.

As illustrated, the example AP 900 includes a processor 905, memory 910, storage 915, one or more transceivers 920, one or more I/O interfaces 970, and one or more network interfaces 925. In some embodiments, I/O devices 940 are connected via the I/O interface(s) 970. Further, via the network interface 925, the AP 900 can be communicatively coupled with one or more other devices and components (e.g., via a network, which may include the Internet, local network(s), and the like). Each of the components is communicatively coupled by one or more buses 930. In some embodiments, one or more antennas 935 may be coupled to the transceivers 920 for transmitting and receiving wireless signals.

The processor 905 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 905 processes information received through the transceiver 920, I/O interfaces 970, and the network interfaces 925. The processor 905 retrieves and executes programming instructions stored in memory 910, as well as stores and retrieves application data residing in storage 915.

The storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 915 may store a variety of data for efficient functioning of the system.

The memory 910 may include random access memory (RAM) and read-only memory (ROM). The memory 910 may store processor-executable software code containing instructions that, when executed by the processor 905, enable the AP 900 to perform various functions described herein for wireless communication. In the illustrated example, the memory 910 includes two software components: the P2P communication component 945 and the WLAN communication component 950. In some embodiments, the P2P communication component 945 may be configured to support the P2P communication. For example, the component 945 may evaluate the current network load and determine the availability of network resources that can be allocated for P2P communications. Based on load assessment and the specific request from devices for P2P communication, the component 945 may dynamically allocate the necessary resources to support these sessions effectively. When receiving extension requests from associated STAs, the component 945 may reevaluate the network load and policies to determine whether it can accommodate the additional demands. In some embodiments, the WLAN communication component 950 may support WLAN communications, such as identifying available WLAN devices within range, handling association and authentication requests to ensure secure access, and monitoring the data transfer over the network.

Although depicted as a discrete component for conceptual clarity, in some embodiments, the operations of the depicted components (and others not illustrated) may be combined or distributed across any number of components. Further, although depicted as software residing in memory 910, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
sending a pre-association request, by a first network device, to a second network device, inquiring about a capacity of the second network device to support a peer-to-peer (P2P) communication within a network;
receiving a pre-association response from the second network device, confirming the capacity of the second network device to support the P2P communication;
sending an association request, by the first network device, to the second network device;
receiving an association response from the second network device, confirming a connection between the first and second network devices within the network; and
conducting the P2P communication, by the first network device, with a third network device, using network resources allocated for the P2P communication by the second network device.

2. The method of claim 1, wherein the second network device comprises an access point.

3. The method of claim 1, wherein the first network device comprises a station (STA) that manages the P2P communication, and the first network device is within a coverage area of the second network device.

4. The method of claim 1, wherein the pre-association response comprises network resources promised to be allocated for the P2P communication by the second network device, and the network resources comprise at least one of a bandwidth allocation or a timeslot for channel usage.

5. The method of claim 4, wherein the network resources allocated for the P2P communication are determined by the second network device, based on an assessment of a current operational load of the second network device, considering at least one of (i) a number of stations (STAs) connected to the second network device, (ii) an amount of data queued up at the second network device, (iii) an amount of data queued up at the connected STAs, (iv) a signal strength between the second network device and the connected STAs.

6. The method of claim 4, further comprising sending an action frame to negotiate the network resources promised to be allocated for the P2P communication by the second network device.

7. The method of claim 4, further comprising:
while conducting the P2P communication, by the first network device, with the third network device, determining that the network resources allocated by the second network device are insufficient; and
sending an extension request to the second network device, requesting additional network resources.

8. The method of claim 1, further comprising:
receiving a second pre-association response from the second network device, indicating that the second network device does not have sufficient bandwidth to support the P2P communication;
identifying a fourth network device; and
sending a second pre-association request, by the first network device, to a fourth network device, inquiring about a capacity of the fourth network device to support the P2P communication within the network.

9. A system comprising:
one or more computer processors; and
one or more memories collectively containing one or more programs, which, when executed by the one or more computer processors, perform operations, the operations comprising:
sending a pre-association request, by a first network device, to a second network device, inquiring about a capacity of the second network device to support a peer-to-peer (P2P) communication within a network;
receiving a pre-association response from the second network device, confirming the capacity of the second network device to support the P2P communication;
sending an association request, by the first network device, to the second network device;
receiving an association response from the second network device, confirming a connection between the first and second network devices within the network; and
conducting the P2P communication, by the first network device, with a third network device, using network resources allocated for the P2P communication by the second network device.

10. The system of claim 9, wherein the second network device comprises an access point.

11. The system of claim 9, wherein the first network device comprises a station (STA) that manages the P2P communication, and the first network device is within a coverage area of the second network device.

12. The system of claim 9, wherein the pre-association response comprises network resources promised to be allocated for the P2P communication by the second network device, and the network resources comprise at least one of a bandwidth allocation or a timeslot for channel usage.

13. The system of claim 12, wherein the network resources allocated for the P2P communication are determined by the second network device, based on an assessment of a current operational load of the second network device, considering at least one of (i) a number of stations (STAs) connected to the second network device, (ii) an amount of data queued up at the second network device, (iii) an amount of data queued up at the connected STAs, (iv) a signal strength between the second network device and the connected STAs.

14. The system of claim 12, wherein the one or more programs, which, when executed on any combination of the one or more computer processors, performs the operations further comprising sending an action frame to negotiate the network resources promised to be allocated for the P2P communication by the second network device.

15. The system of claim 12, wherein the one or more programs, which, when executed on any combination of the one or more computer processors, performs the operations further comprising:
while conducting the P2P communication, by the first network device with the third network device, determining that the network resources allocated by the second network device are insufficient; and
sending an extension request to the second network device, requesting additional network resources.

16. The system of claim 9, wherein the one or more programs, which, when executed on any combination of the one or more computer processors, performs the operations further comprising:
receiving an second pre-association response from the second network device, indicating that the second network device does not have sufficient bandwidth to support the P2P communication;
identifying a fourth network device; and
sending a second pre-association request, by the first network device, to a fourth network device, inquiring about a capacity of the fourth network device to support the P2P communication within the network.

17. One or more non-transitory computer-readable media containing, in any combination, computer program code that, when executed by a computer system, performs operations comprising:
sending a pre-association request, by a first network device, to a second network device, inquiring about a capacity of the second network device to support a peer-to-peer (P2P) communication within a network;
receiving a pre-association response from the second network device, confirming the capacity of the second network device to support the P2P communication;
sending an association request, by the first network device, to the second network device;
receiving an association response from the second network device, confirming a connection between the first and second network devices within the network; and
conducting the P2P communication, by the first network device, with a third network device, using network resources allocated for the P2P communication by the second network device.

18. The one or more non-transitory computer-readable media of claim 17, wherein the pre-association response comprises network resources promised to be allocated for the P2P communication by the second network device, and the network resources comprise at least one of a bandwidth allocation or a timeslot for channel usage.

19. The one or more non-transitory computer-readable media of claim 18, wherein the network resources allocated for the P2P communication are determined by the second network device, based on an assessment of a current operational load of the second network device, considering at least one of (i) a number of stations (STAs) connected to the second network device, (ii) an amount of data queued up at the second network device, (iii) an amount of data queued up at the connected STAs, (iv) a signal strength between the second network device and the connected STAs.

20. The one or more non-transitory computer-readable media of claim 17, wherein the computer program code, which, when executed by the computer system, performs the operations further comprising:
while conducting the P2P communication, by the first network device with the third network device, determining that the network resources allocated by the second network device are insufficient; and
sending an extension request to the second network device, requesting additional network resources.
